(19) United States
(12) Patent Application Publication
(10) Pub. No.: US 2005/0176304 A1
(43) Pub. Date: Aug. 11, 2005

(54) Memory card connector

(76) Inventor: Jung-Hua Yiu, Tu-Cheng (TW)

Correspondence Address: Ann Tsai;Suite 137, PmB 174, 931 West 75th Street, Naperville, IL, 60565, US

(21) Appl. No.: 10/773,039

(22) Filed: Feb. 6, 2004

(51) Int. Cl. H01R 24/00

(52) U.S. Cl. 439/630

(57) ABSTRACT

A memory card connector includes a main body and four sets of pins. The main body is integrally formed by way of plastic injection, provided with four sets of pin locating seats at the periphery thereof and has a socket opening at a side thereof for being inserted with four memory cards in different specifications. The socket opening provides multiple narrow recesses in different sizes and the narrow recesses partly overlap with each other. The four sets of pins are inset to the four pin locating seats respectively. The socket opening at two opposite lateral sides thereof extends inward a groove passage respectively and at the inner lower side thereof provides a fifth set of pin locating seats corresponding a fifth set of pins, which are used for correspond an XD card. The socket opening can be inserted with five different types of memory cards.

### BACKGROUND OF THE INVENTION

1. Field of the Invention

The present invention is related to a memory card connector and particularly to an improved structure of memory card connector, which can be inserted with an XD card in addition to four original memory cards.

2. Brief Description of Related Art

Usually, a memory card mainly is used as a storage media for digital peripheral products. Currently, a variety of brands and types of digital peripheral products being available on the market and a specific memory card only fits a certain brand of digital peripheral product so that there are also a lot of memory cards in different shapes or sizes to accommodate different memory card connectors for the digital peripheral products. In this way, it is not possible for the memory card connectors to be interchangeable while in use and it frequently results in a memory card bought by the user is useless. Although the prior art such as Taiwanese Utility Model Publication No. 487881 entitled “DUAL CARD TYPE OF MULTI MEDIA CARD AND SECURE DIGITAL CARD” and Taiwanese Utility Model Publication No. 559352 entitled “DUAL CARD TYPE OF SMART MEDIA CARD AND XD CARD” disclose a memory cart connector for being inserted with two memory cards, it is not possible to satisfy the user's need. The prior art such as Taiwanese Utility Model Publication No. 464110 entitled “SIGNAL SWITCHING DEVICE OF MEMORY CARDS, Taiwanese Utility Model Publication No. 495110 entitled “COMMON SOCKET FOR MEMORY CARDS”, Taiwanese Utility Model Publication No. 547800 entitled “MEMORY CARD CONNECTOR”, Taiwanese Utility Model Publication No. 553518 entitled “COMMON TYPE MEMORY CARD CONNECTOR” and Taiwanese Utility Model Publication No. 559404 entitled “IMPROVED ELETRONIC MEMORY CARDCONNECTING BASE” discloses a memory card connector for four different memory cards, which are Smart Media Card, Secure Digital Card, Multi Media Card and Memory Stick Card. But, the prior art only can be used for four kinds of memory cards in spite of being capable of accommodating memory cards in different sizes. In order to be capable of being used with five different memory cards, the prior art such as Taiwanese Utility Model Publication No. 558088 entitled “INDEPENDENT MULTIPLE GROOVE TYPE MEMORY CARD CONNECTOR” discloses two combined connectors for being able to be inserted with five different memory cards. But, the prior art provides a huge size with complicated fabrication work and high cost and it does not meet the trend of smallness.

### SUMMARY OF THE INVENTION

A main object of the present invention is to provide a memory card connector, which includes a main body and four sets of pins. The main body is integrally formed by way of plastic injection molding, provided with four sets of pin locating seats at the periphery thereof and has a socket opening at a side thereof for being inserted with four memory cards in different specifications. The socket opening provides multiple narrow recesses in different sizes and the narrow recesses partly overlap with each other. The four sets of pins are inset to the four pin locating seats respectively.

The socket opening at two opposite lateral sides thereof extends inward a groove passage respectively and at the inner lower side thereof provides a fifth set of pin locating seats corresponding a fifth set of pins, which are used for correspond an XD card. The socket opening can be inserted with five different types of memory cards.

### BRIEFE DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of a memory card connector according to the present invention in a preferred embodiment thereof;

FIG. 2 is an assembled perspective view of the memory card connector shown in FIG. 1;

FIG. 3 is a partly fragmentary perspective view of FIG. 2;

FIG. 4 is a perspective view illustrating pins being assembled to the memory card connector of the preceding embodiment;

FIG. 5A is a plan view illustrating the memory card connector of the present inventor being inserted with a smart media card;

FIG. 5B is a sectional view of FIG. 5A;

FIG. 6A is a plan view illustrating the memory card connector of the present inventor being inserted with a memory stick card;

FIG. 6B is a sectional view of FIG. 6A;

FIG. 7A is a plan view illustrating the memory card connector of the present inventor being inserted with a secure digital card;

FIG. 7B is a sectional view of FIG. 7A;

FIG. 8A is a plan view illustrating the memory card connector of the present inventor being inserted with a multi media card;

FIG. 8B is a sectional view of FIG. 8A;

FIG. 9A is a plan view illustrating the memory card connector of the present inventor being inserted with a XD card; and

FIG. 9B is a plan view of FIG. 9A.

### DETAILED DESCRIPTION OF THE PREFERRED EMBODIMENT

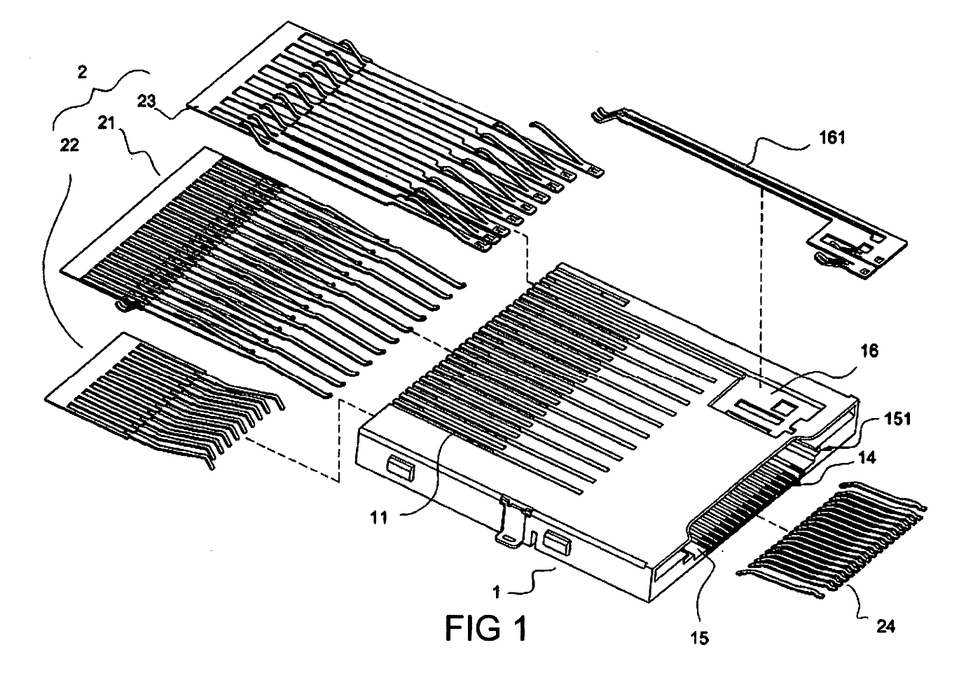

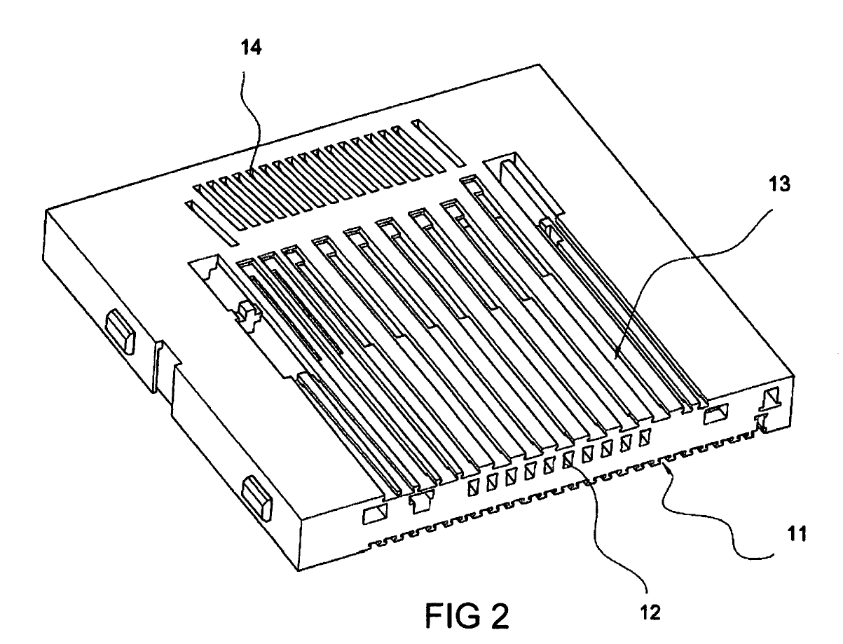

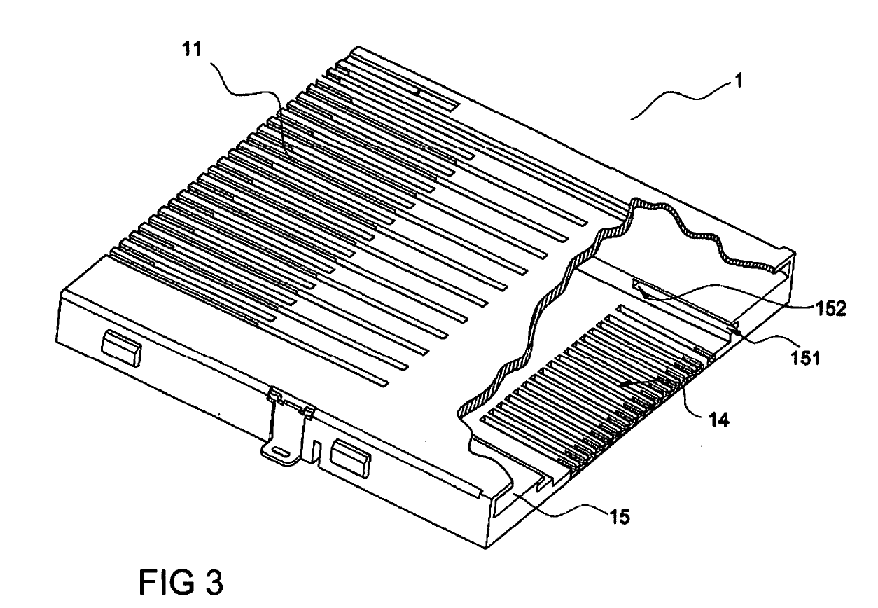

Referring to FIGS. 1, 2 and 3, a memory card connector according to the present invention in a preferred embodiment thereof is illustrated. The memory card connector of the present invention is composed of a main body 1 and pin set 2. The main body 1 is integrally made by way of plastic injection molding with a socket opening 15 being located at an end thereof accommodating for four different memory cards in specification. The socket opening 15 provides multiple narrow recesses in different sizes and these narrow recesses partly overlap with each other so that the space in the opening 15 has a configuration extending steps. The main body 1 at the periphery thereof is provided with locating seats 11, 12, 13 and 14 as shown in FIG. 2 for retaining different pins 21, 22, 23 and 24. One of the narrow recesses at right and left sides thereof extends inward a recess passage 151 respectively as shown in FIG. 3 and each of the recess passages 151 has an inner stop end 152 for limiting an inserted XD card (E). Further the main body 1 at the outer side thereof is provided with a recess 16 for locating a write protection device 161. The pin set 2 can be divided into four different pins 21, 22, 23 and 24 for being suitable for a smart media card (A), a secure digital card (B), a memory stick card (C) and the XD card (E).

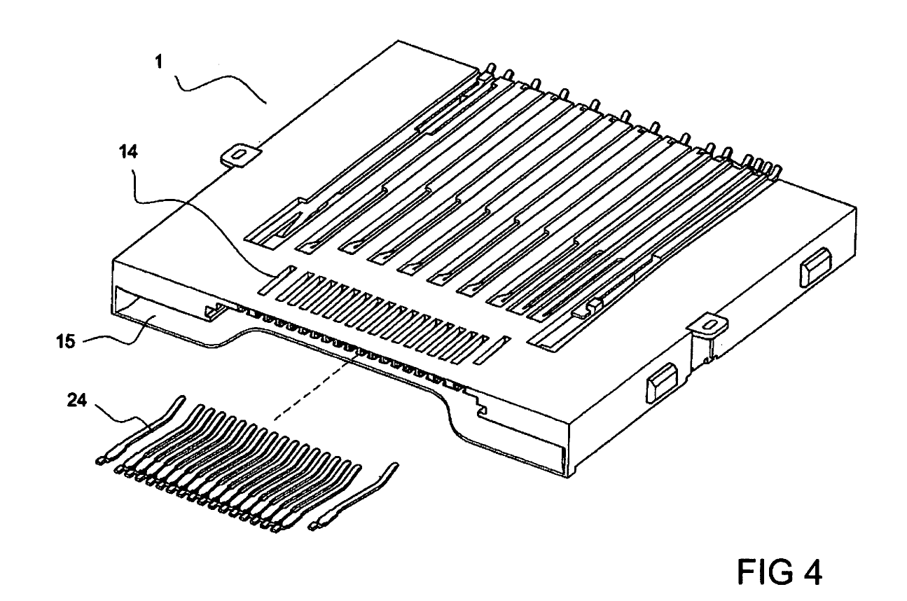

Referring to FIGS. 4, 5 and 6, during assembling the memory card connector, the pins 21, 22, 23 and 24 of the pin set 2 are inset to the corresponding locating seats 11, 12, 13 and 14 respectively and the write protection device 161 is inserted into the recess 16. Then, the pins 21, 22, 23 and 24 are soldered to preset circuits of a circuit board (not shown in the figures). Next, the assembled components are fixedly attached to a digital media video device or to a computer and periphery thereof to complete the assembly.

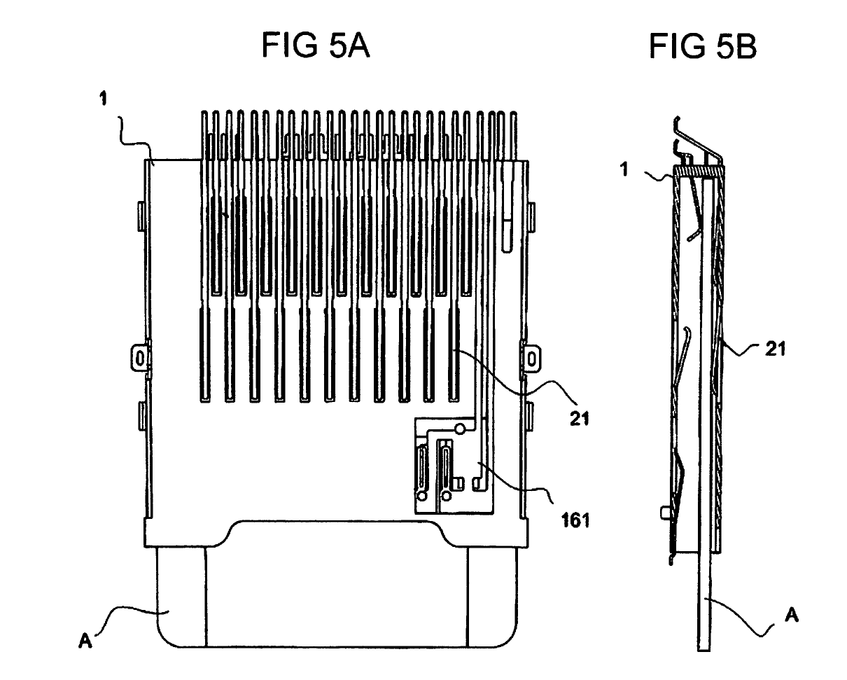

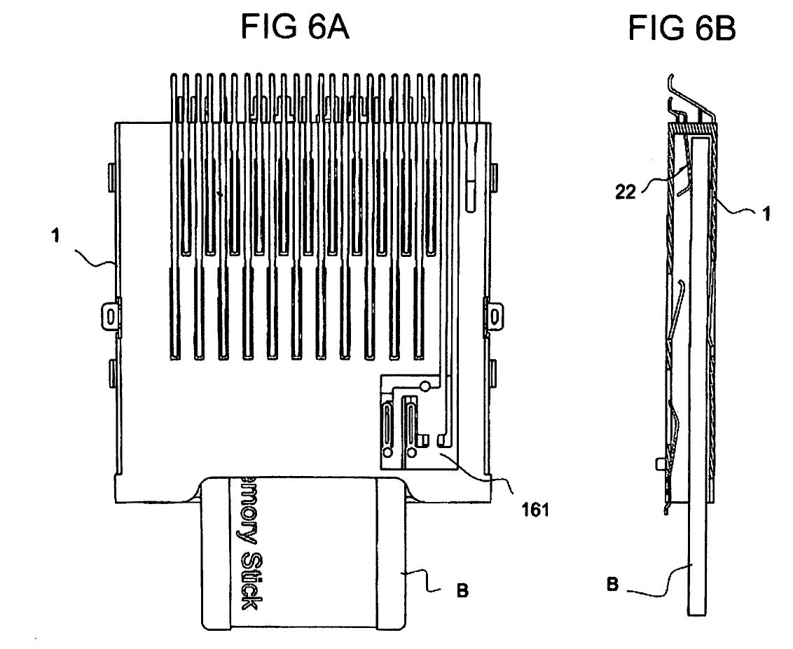

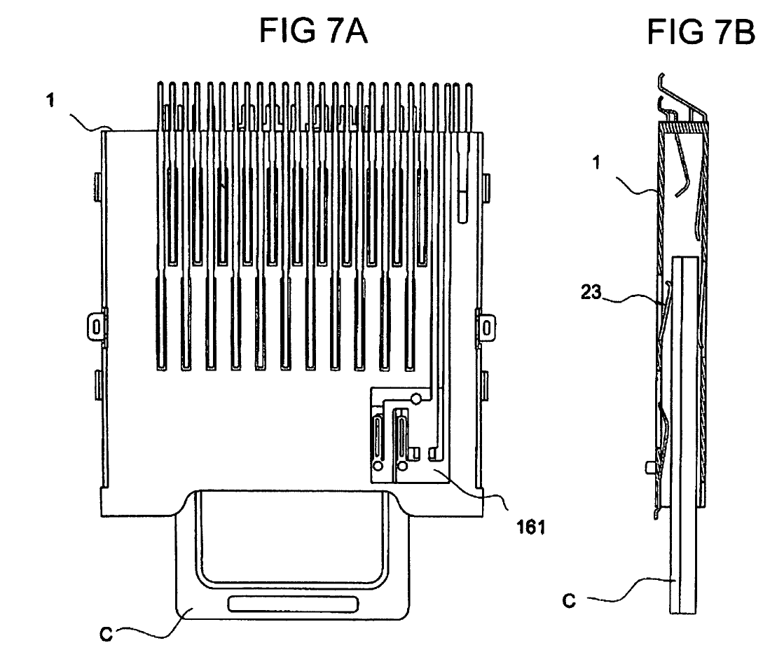

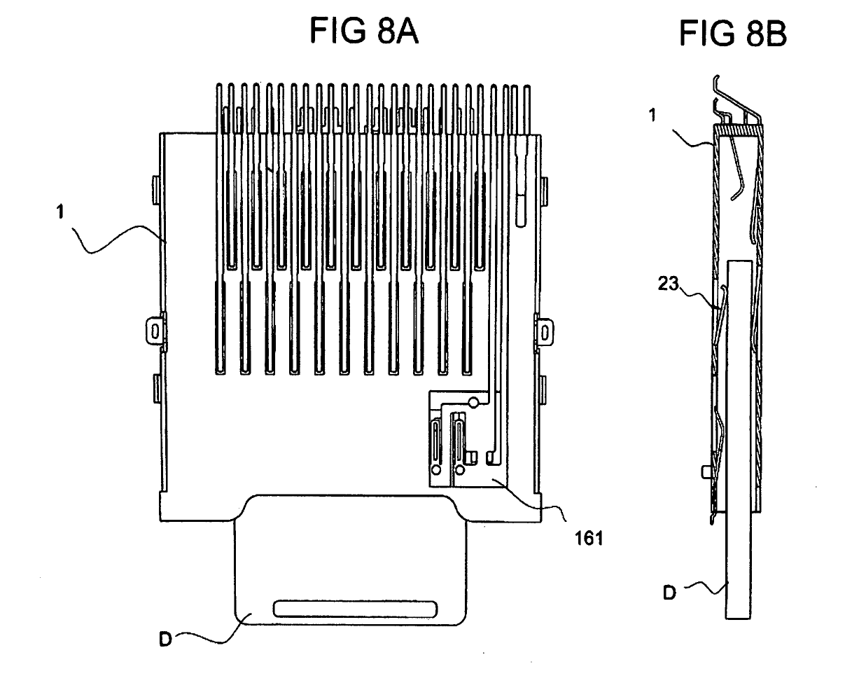

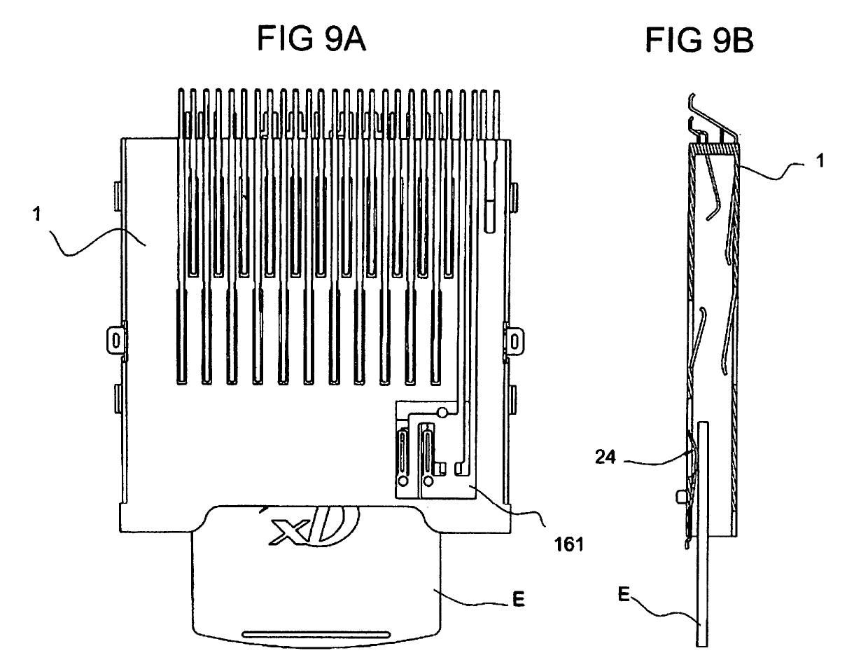

While in use, memory cards in different specifications are inserted into the assembled memory card connector and chips on the smart media card (A), the secure digital card (C), the multi media card (D), the memory stick card (B) and the XD card (E) can electrically connect the corresponding pins 21, 22, 23 and 24 respectively. The pins 21 are suitable for connecting the smart media card (A) as shown in FIGS. 5A and 5. The pins 22 are suitable for the memory stick (B) as shown in FIGS. 6A and 6B. The pins 23 are suitable for secure digital card (C) and multi media card (E) as shown in FIGS. 7 and 8. The pins 24 are suitable for the XD card (E) as shown in FIG. 9.

It is appreciated that the memory card connector according to the present invention provides a simple structure, which allows four different types of pins being inserted in the connector, to obtain utilization of space perfectly so that it can accommodate five different types of memory cards under a condition of not increasing the volume thereof. Therefore, the memory card connector of the present invention is better than the prior art regardless fabrication and assembly works in addition to less production cost.

While the invention has been described with referencing to a preferred embodiment thereof, it is to be understood that modifications or variations may be easily made without departing from the spirit of this invention, which is defined by the appended claims.

1. A memory card connector, comprising:
a main body, being integrally formed by way of plastic injection molding, being provided with four sets of pin locating seats at a periphery thereof, having a socket opening at a side thereof for being inserted with four memory cards in different specifications, the socket opening providing multiple narrow recesses in different sizes and said narrow recesses partly overlap with each other; and
a plurality of pins, being inset to the pin locating seats;
characterized in that the socket opening at two opposite lateral sides thereof extends inward a groove passage respectively and at an inner lower side thereof provides a fifth set of pin locating seats corresponding a fifth set of pins, which are used for correspond an XD card;
whereby, the socket opening can be inserted with five different types of memory cards without increasing size and production cost of the memory card connector.

2. The memory card connector as defined in claim 1, wherein the groove passage at an inner end thereof has a stop part.

3. The memory card connector as defined in claim 1, wherein a write protection device is provided in the main body.
